(19) United States
(12) Patent Application Publication
(10) Pub. No.: US 2021/0133457 A1
(43) Pub. Date: May 6, 2021

(54) METHOD, COMPUTER DEVICE, AND STORAGE MEDIUM FOR VIDEO ACTION CLASSIFICATION

(71) Applicant: Beijing Dajia Internet Information Technology Co., Ltd., Beijing (CN)

(72) Inventors: Zhiwei ZHANG, Beijing (CN); Yan LI, Beijing (CN)

(21) Appl. No.: 17/148,106

(22) Filed: Jan. 13, 2021

Related U.S. Application Data
(63) Continuation of application No. PCT/CN2019/106250, filed on Sep. 17, 2019.

(30) Foreign Application Priority Data
Nov. 28, 2018 (CN) 201811437221.X

(51) Int. Cl. G06K 9/00; G06K 9/62; G06N 3/04; G06N 3/08

(52) U.S. Cl. CPC G06K 9/00718; G06K 9/628; G06N 3/08; G06N 3/04; G06K 9/624

(57) ABSTRACT

Disclosed are a video motion classification method, an apparatus, a computer device, and a storage medium. The method includes: a video to be classified is acquired and a plurality of video frames in the video to be classified are determined; the plurality of video frames are input into an optical flow substitution module in a trained video motion classification optimization model to obtain optical flow feature information corresponding to the plurality of video frames; the plurality of video frames are input into a three-dimensional convolutional neural module in the trained video motion classification optimization model to obtain spatial feature information corresponding to the plurality of video frames; and on the basis of the optical flow feature information and the spatial feature information, classification category information corresponding to the video to be classified is determined.

### CROSS-REFERENCE OF RELATED APPLICATIONS

This application is the continuation application of International Application No. PCT/CN2019/106250, filed on Sep. 17, 2019, which is based upon and claims the priority from Chinese Patent Application No. 201811437221.X, filed with the China National Intellectual Property Administration on Nov. 28, 2018 and entitled “Method and Apparatus, Computer Device and Storage Medium for Video Action Classification”, which is hereby incorporated by reference in its entirety.

### FIELD

The disclosure relate to the technical field of machine learning models, and in particular to a method and apparatus, a computer device and a storage medium for video action classification.

### BACKGROUND

With the development of society, more and more people like to use the fragmented time to watch or shoot short videos. When any user uploads a shot short video to a short video platform, the relevant personnel in the short video platform can view the short video and classify the actions of objects in the short video based on subjective understanding, such as dancing, climbing a tree, drinking water, etc. Then the short video can be labeled with a corresponding tag based on the classification result.

### SUMMARY

According to a first aspect, a method for video action classification is provided. The method includes: acquiring a video to be classified and determining a plurality of video frames in the video to be classified; determining optical flow information corresponding to the plurality of video frames based on the plurality of video frames and an optical flow substitution module in a trained video action classification optimization model; determining spatial feature information corresponding to the plurality of video frames based on the plurality of video frames and a three-dimensional convolution neural network module in the trained video action classification optimization model; and determining classification category information corresponding to the video to be classified based on the optical flow information and the spatial feature information.

According to a second aspect, an apparatus for video action classification is provided. The method includes a first determining unit, a first input unit and a second determining unit. The first determining unit is configured to acquire a video to be classified and determine a plurality of video frames in the video to be classified. The first input unit is configured to determine optical flow information corresponding to the plurality of video frames based on the plurality of video frames and an optical flow substitution module in a trained video action classification optimization model; and determine spatial feature information corresponding to the plurality of video frames based on the plurality of video frames and a three-dimensional convolution neural network module in the trained video action classification optimization model. The second determining unit is configured to determine classification category information corresponding to the video to be classified based on the optical flow information and the spatial feature information.

According to a third aspect, a computer device is provided. The computer device includes a processor, and a memory for storing instructions that can be executed by the processor. The processor is configured to perform: acquiring a video to be classified and determining a plurality of video frames in the video to be classified; determining optical flow information corresponding to the plurality of video frames based on the plurality of video frames and an optical flow substitution module in a trained video action classification optimization model; determining spatial feature information corresponding to the plurality of video frames based on the plurality of video frames and a three-dimensional convolution neural network module in the trained video action classification optimization model; and determining classification category information corresponding to the video to be classified based on the optical flow information and the spatial feature information.

According to a fourth aspect, a non-transitory computer-readable storage medium is provided. The instructions in the storage medium, when executed by a processor of a computer device, enable the computer device to perform a method for video action classification, which includes: acquiring a video to be classified and determining a plurality of video frames in the video to be classified; determining optical flow information corresponding to the plurality of video frames based on the plurality of video frames and an optical flow substitution module in a trained video action classification optimization model; determining spatial feature information corresponding to the plurality of video frames based on the plurality of video frames and a three-dimensional convolution neural network module in the trained video action classification optimization model; and determining classification category information corresponding to the video to be classified based on the optical flow information and the spatial feature information.

According to a fifth aspect, a computer program product is provided. The computer program product, when executed by a processor of a computer device, enables the computer device to perform a method for video action classification, which includes: acquiring a video to be classified and determining a plurality of video frames in the video to be classified; determining optical flow information corresponding to the plurality of video frames based on the plurality of video frames and an optical flow substitution module in a trained video action classification optimization model; determining spatial feature information corresponding, to the plurality of video frames based on the plurality of video frames and a three-dimensional convolution neural network module in the trained video action classification optimization model; and determining classification category information corresponding to the video to be classified based on the optical flow information and the spatial feature information.

### BRIEF DESCRIPTION OF THE DRAWINGS

The accompanying drawings here are incorporated into and constitute a part of the specification, illustrate the embodiments conforming to the disclosure, and together with the specification, serve to explain the principles of the disclosure.

FIG. 1 is a flow chart of a method for video action classification according to an exemplary embodiment;

FIG. 2 is a flow chart of a method for video action classification according to an exemplary embodiment;

FIG. 3 is a flow chart of a method for training a video action classification optimization model according to an exemplary embodiment;

FIG. 4 is a flow chart of a method for training a video action classification optimization model according to an exemplary embodiment;

FIG. 5 is a block diagram of an apparatus for video action classification according to an exemplary embodiment;

FIG. 6 is a block diagram of an apparatus for video action classification according to an exemplary embodiment.

### DETAILED DESCRIPTION OF THE EMBODIMENTS

The exemplary embodiments will be illustrated here in details, and the examples thereof are represented in the drawings. When the following description relates to the drawings, the same numbers represent the same or similar elements in the different drawings, unless otherwise indicated. The implementation modes described in the following exemplary embodiments do not represent all the implementation modes consistent with the disclosure. On the contrary, they are only the examples of the devices and methods which are detailed in the attached claims and consistent with some aspects of the disclosure.

With the development of society, more and more people like to use the fragmented time to watch or shoot short videos. When a user uploads a shot short video to a short video platform, the video platform needs to classify the actions of objects in the short video, such as dancing, climbing a tree, drinking water, etc., and then adds the corresponding tag to the short video based on the classification result. In some embodiments of the disclosure, a method that can automatically classify short videos is provided.

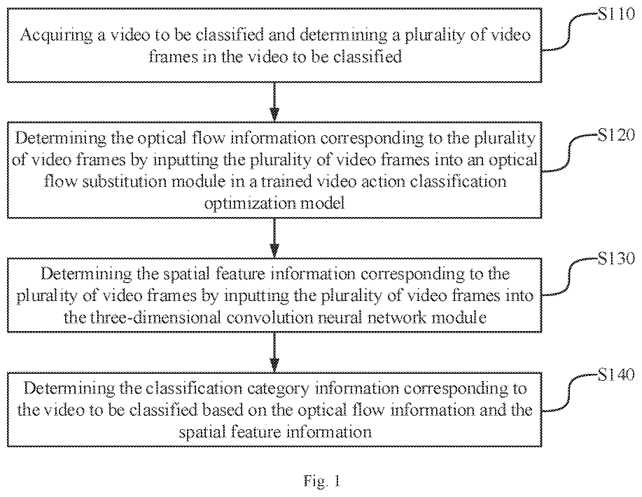

FIG. 1 is a flow chart of a video action classification method according to an exemplary embodiment. As shown in FIG. 1, the method is used in a server of a short video platform and includes the following steps.

S110: acquiring a video to be classified and determining a plurality of video frames in the video to be classified.

In an implementation, the server can receive a large number of short videos uploaded by users, any short video being taken as the video to be classified, so the server can obtain the video to be classified. Since a video to be classified consists of many video frames and it is not necessary to use all the video frames in subsequent steps, the server can extract a preset number of video frames from all the video frames. In some embodiments, the server may randomly extract a preset number of video frames from all the video frames. The preset number may be set based on experience, for example, the preset number is set as 10, or 5, or the like.

S120: determining the optical flow information corresponding to the plurality of video frames by inputting the plurality of video frames into an optical flow substitution module in a trained video action classification optimization model.

In some embodiments, the video action classification optimization model may be trained in advance for processing the videos to be classified. The video action classification optimization model includes a plurality of functional modules, each of which plays a different role. The video action classification optimization model may include an optical flow substitution module, a three-dimensional convolution neural network module, and a first classifier module.

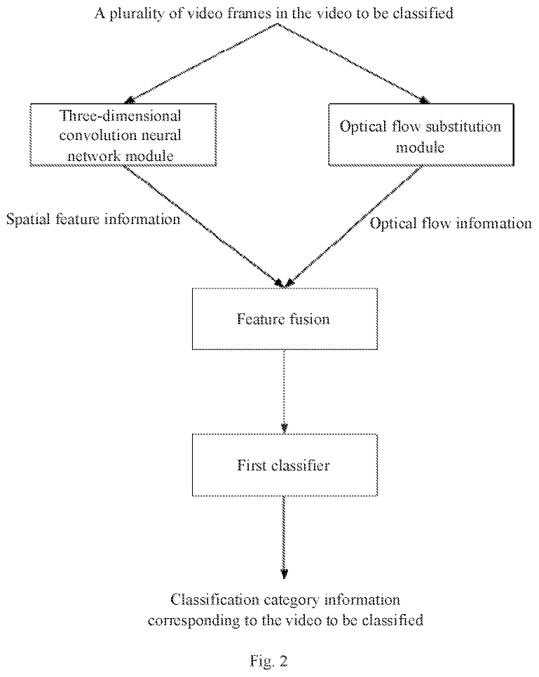

The optical flow substitution module is used to extract the optical flow information corresponding to the plurality of video frames. As shown in FIG. 2, in response to that the server inputs a plurality of video frames into the optical flow substitution module, the optical flow substitution module can output the optical flow information corresponding to the plurality of video frames. The optical flow information refers to a. motion vector corresponding to an object included in the plurality of video frames, that is, in what direction the object moves from the position in the first video frame to the position in the last video frame among the plurality of video frames.

S130: determining the spatial feature information corresponding to the plurality of video frames by inputting the plurality of video frames into the three-dimensional convolution neural network module.

Here, the three-dimensional convolution neural network module may include a C3D (3 Dimensions Convolution) module.

In some embodiments, the three-dimensional convolution neural network module is used to extract the spatial feature information corresponding to the plurality of video frames. As shown in FIG. 2, in response to that the server inputs a plurality of video frames into the three-dimensional convolution neural network module, the three-dimensional convolution neural network module can output the spatial feature information corresponding to the plurality of video frames. The spatial feature information refers to the positions of an object included in a. plurality of video frames in each video frame. The spatial feature information consists of a set of three-dimensional information, where two dimensions in the three-dimensional information may represent the position of the object in a video frame, and the last dimension may represent the shooting moment corresponding to the video frame,

S140: determining the classification category information corresponding to the video to be classified based on the optical flow information and the spatial feature information.

In some embodiments, after obtaining the optical flow information and the spatial feature information, the server may perform the feature fusion on the optical flow information and the spatial feature information. In some embodiments, the feature fusion may be performed on the optical flow information and the spatial feature information based on the CONCAT sentence, and the fused optical flow information and spatial feature information may be input into the first classifier module. Then the first classifier module outputs the classification category information corresponding to the optical flow information and the spatial feature information as the classification category information corresponding to the video to be classified, realizing the end-to-end classification processing.

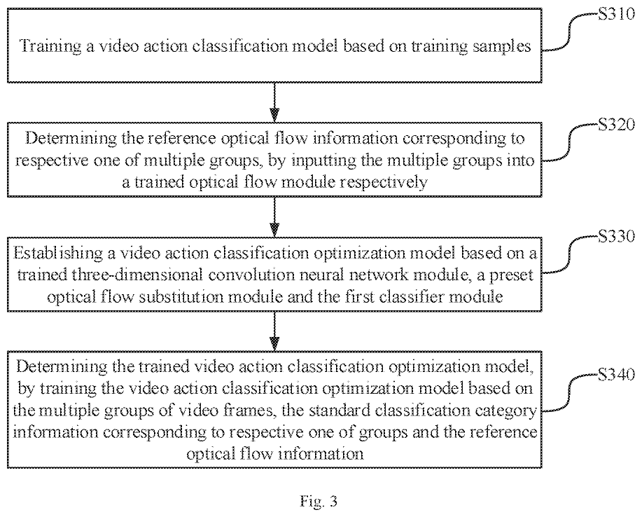

In some embodiments, as shown in FIG. 3, the method may further include the following steps:

S310: training a video action classification model based on training samples, where the training samples include multiple groups of video frames and the standard classification category information corresponding to respective one of the multiple groups, and the video action classification model includes a three-dimensional convolution neural network module and an optical flow module;

S320: determining the reference optical flow information corresponding to respective one of multiple groups, by inputting the multiple groups into a trained optical flow module respectively;

S330: establishing a video action classification optimization model based on a trained three-dimensional convolution neural network module, a preset optical flow substitution module and the first classifier module;

S340: determining the trained video action classification optimization model, by training the video action classification optimization model based on the multiple groups of video frames, the standard classification category information corresponding to respective one of groups and the reference optical flow information.

In some embodiments, before the trained video action classification optimization model is used to classify the video to be classified, the video action classification optimization model needs to be trained in advance. In some embodiments, the process of training the video action classification optimization model may have two stages. In the first stage, the video action classification model may be trained based on training samples. In the second stage, the reference optical flow information corresponding to each group of video frames is determined, by inputting multiple groups of video frames to the trained optical flow module respectively; the video action classification optimization model is established based on the trained three-dimensional convolution neural network module, the preset optical flow substitution module and the first classifier module; and the trained video action classification optimization model is obtained by training the video action classification optimization model based on the multiple groups of video frames, the standard classification category information corresponding to each group of video frames and the reference optical flow information.

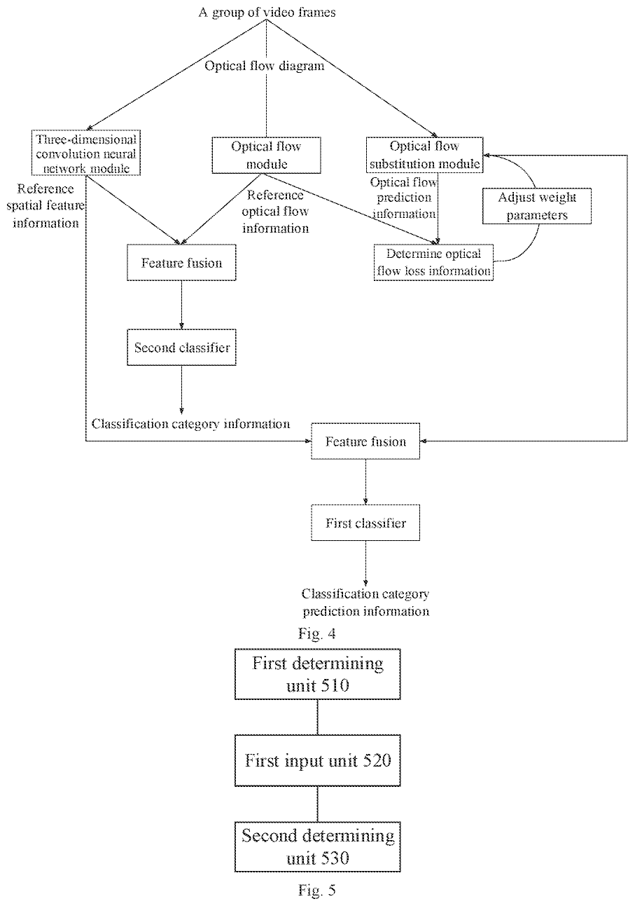

As shown in FIG. 4, in the first stage, the video action classification model may be firstly established based on the three-dimensional convolution neural network module, optical flow module and second classifier module. The three-dimensional convolution neural network module is used to extract the spatial feature information corresponding to a group of video frames, the optical flow module is used to extract the optical flow information corresponding to the group, and the second classifier module is used to determine the classification category prediction information corresponding to the group based on the spatial feature information and optical flow information.

In some embodiments, the three-dimensional convolution neural network module can extract the spatial feature information corresponding to respective one of groups of video frames in response to that inputting multiple groups in the training samples into the three-dimensional convolution neural network module. While, the optical flow diagrams corresponding to respective one of groups may be determined respectively in advance based on the multiple groups of video frames without using the video action classification model. The optical flow module can output the optical flow information corresponding to each group of video frames in response to that each optical flow diagram is input into optical flow module. Then the feature fusion may be performed on the spatial feature information and optical flow information corresponding to each group, and the second classifier module can output the classification category prediction information corresponding to each group of video frames, in response to that the fused spatial feature information and optical flow information corresponding to each group are input into the second classifier module.

In some embodiments, the standard classification category information corresponding to each group of video frames in the training samples is taken as the supervisory information, and the difference between the classification category prediction information and the standard classification category information corresponding to each group of video frames is determined. Then the weight parameters in the video action classification model may be adjusted based on the difference information corresponding to each group of video frames. Then a trained video action classification model is obtained in response to that it is determined that the video action classification model converges by repeating the above process. The difference information may be the cross entropy distance. The calculation formula of the cross entropy distance may refer to formula 1:

loss_{entropy}=cross_entropy(ŷ,y) (Formula 1)

where loss_{entropy} is the cross entropy distance, ŷ refers to the classification category prediction information, and y refers to the standard classification category information.

As shown in FIG. 4, in the second stage, since, in the first stage, the video action classification model has been trained and the optical flow module in the video action classification model has also been trained (that is, the trained optical flow module can accurately extract the optical flow information corresponding to each group of video frames), the reference optical flow information output by the converged optical flow module can be taken as the supervisory information and added to the training samples for subsequent training of other modules.

In response to that the the optical flow module is detected to be converged, the weight parameters in the optical flow module can be frozen, and the weight parameters in the optical flow module is no longer adjusted. Then, the three-dimensional convolution neural network module, the preset optical flow substitution module and the first classifier module can be taken as modules in the video action classification optimization model to train the video action classification optimization model.

In some embodiments, the training of the three-dimensional convolution neural network module can be continued, so that the accuracy of the result output by the three-dimensional convolution neural network module becomes higher and higher. The optical flow substitution module can also be trained so that the optical flow substitution module can substitute the optical flow module to extract the optical flow information corresponding to each group of video frames.

In some embodiments, the video action classification optimization model may be trained based on multiple groups of video frames, the standard classification category information and the reference optical flow information corresponding to respective one of groups, to obtain the trained video action classification optimization model.

In some embodiments. S340 may include: determining the optical flow prediction information corresponding to each group of video frames by inputting multiple groups of video frames to the optical flow substitution module respectively; determining the optical flow loss information corresponding to each group of video frames based on the reference optical flow information and the optical flow prediction information corresponding to each group of video frames; determining the reference spatial feature information corresponding to each group of video frames by inputting the multiple groups of video frames to the trained three-dimensional convolution neural network module respectively; determining the classification category prediction information corresponding to each group of video frames by inputting the optical flow prediction information and the reference spatial feature information corresponding to each group of video frames to the first classifier module; determining the classification loss information corresponding to each group of video frames based on the standard classification category information and the classification category prediction information corresponding to each group of video frames; and adjusting weight parameters in the optical flow substitution module based on the optical flow loss information and the classification loss information corresponding to each group of video frames, and adjusting weight parameters in the first classifier module based on the classification loss information corresponding to each group of video frames.

In sonic embodiments, multiple groups of video frames may be directly input into the optical flow substitution module, without determining the optical flow diagram corresponding to each group of video frames respectively based on multiple groups of video frames outside the video action classification optimization model in advance. That is, the optical flow substitution module may directly take multiple groups of video frames, rather than the optical flow diagrams, as inputs. In response to that multiple groups of video frames are respectively input into the optical flow substitution module, the optical flow substitution module output the optical flow prediction information corresponding to each group of video frames.

Since the reference optical flow information corresponding to each group of video frames has been obtained in the first stage, the optical flow loss information corresponding to each group of video frames can be determined based on the reference optical flow information as the supervisory information and the optical flow prediction information corresponding to each group of video frames.

In a possible embodiment, the Euclidean distance between the reference optical flow information and the optical flow prediction information corresponding to each group of video frames may be determined as the optical flow loss information corresponding to each group of video frames. The calculation formula of the Euclidean distance may refer to formula 2:

$${loss}_{flow} = \frac{1}{2} {\sum }_{i = 1}^{\# feat} {\vert {feat}_{i}^{RGB} - {feat}_{i}^{flow} \vert}^{2} \qquad ( Formula 2 )$$

where loss_{flow} is the Euclidean distance, is the quantity of groups, #feat is the quantity of groups, featᵢ^{RGB} is the optical flow prediction information corresponding to the i^{th} group, and featᵢ^{flow} is the reference optical flow information corresponding to the group.

In some embodiments, multiple groups of video frames are respectively input to the trained three-dimensional convolution neural network module to obtain the reference spatial feature information corresponding. to each group of video frames, the feature fusion is performed on the optical flow prediction information and reference spatial feature information corresponding to each group of video frames, and the classification category prediction information corresponding to each group of video frames can be determined by inputting the optical flow prediction information and reference spatial feature information corresponding to each group of video frames after fusion to the first classifier module.

In some embodiments, the classification loss information corresponding to each group of video frames is determined based on the standard classification category information and the classification category prediction information corresponding to each group of video frames. In some embodiments, the cross entropy distance between the standard classification category information and the classification category prediction information corresponding to each group of video frames may be calculated as the classification loss information corresponding to each group. The weight parameters in the optical flow substitution module are adjusted based on the optical flow loss information and the classification loss information corresponding to each group of video frames, and the weight parameters in the classifier module are adjusted based on the classification loss information corresponding to each group of video frames.

In some embodiments, the step of adjusting the weight parameters in the optical flow substitution module based on the optical flow loss information and the classification loss information corresponding to each group of video frames may include: adjusting the weight parameters in the optical flow substitution module based on the optical flow loss information, the classification loss information and a preset adjustment proportional coefficient corresponding to each group of video frames.

In some embodiments, the adjustment proportional coefficient represents an adjustment range for adjusting the weight parameters in the optical flow substitution module based on the optical flow loss information.

In some embodiments, since the weight parameters in the optical flow substitution module are affected by the loss information in two aspects, i.e., the optical flow loss information and the classification loss information corresponding to each group of video frames, the adjustment range can be adjusted by adjusting the proportional coefficient. The calculation formula of the optical flow loss information and the classification loss information may refer to formula 3:

$${loss}_{flow} = cross\_entropy ( \hat{y} , y ) + \frac{λ}{2} {\sum }_{i = 1}^{\# feat} {\vert {feat}_{i}^{RGB} - {feat}_{i}^{flow} \vert}^{2} \qquad ( Formula 3 )$$

where cross_entropy(ŷ,y) is the classification loss information, λ is the adjustment proportional coefficient, loss_{flow} is the Euclidean distance, #feat is the quantity of groups of video frames, featᵢ^{RGB} is the optical flow prediction information corresponding to the i^{th} group, and featᵢ^{flow} is the reference optical flow information corresponding to the group.

The weight parameters in the optical flow substitution module may be adjusted by formula 3, until it is determined that the optical flow substitution module converges, to obtain the trained optical flow substitution module. At this time, it can be considered that the video action classification optimization model has been trained and the running codes corresponding to the optical flow module can be deleted.

With the method provided by the embodiments of the disclosure, a plurality of video frames of the video to be classified can be directly input into the trained video action classification optimization model, the trained video action classification optimization model can automatically classify the video to be classified, and finally, the classification category information corresponding to the video to be classified is obtained, improving the efficiency of classification processing. In the process of classifying the video to be classified by the trained video action classification optimization model, it is no longer necessary to determine the optical flow diagrams corresponding to a plurality of video frames in advance based on the plurality of video frames. The plurality of video frames may be directly taken as the inputs of the optical flow substitution module in the model, and the optical flow substitution module can directly extract the optical flow information corresponding to the plurality of video frames and determine the classification category information corresponding to the video to be classified based on the optical flow information, further improving the efficiency of classification processing.

FIG. 5 is a block diagram of an apparatus for video action classification according to an exemplary embodiment. Referring to FIG. 5, the apparatus includes a first determining unit 510, a first input unit 520 and a second determining unit 530.

The first determining unit 510 is configured to acquire a video to be classified and determine a plurality of video frames in the video to be classified.

The first input unit 520 is configured to determine the optical flow information corresponding to the plurality of video frames by inputting the plurality of video frames into an optical flow substitution module in a trained video action classification optimization model; and determine the spatial feature information corresponding to the plurality of video frames by inputting the plurality of video frames into the three-dimensional convolution neural network module.

The second determining unit 530 is configured to determine the classification category information corresponding to the video to be classified based on the optical flow information and the spatial feature information.

In some embodiments, the apparatus further includes:

a first training unit configured to train a video action classification model based on training samples, where the training samples include multiple groups of video frames and the standard classification category information corresponding to respective one of the multiple groups, and the video action classification model includes a three-dimensional convolution neural network module and an optical flow module;

a second input unit configured to determine the reference optical flow information corresponding to respective one of multiple groups, by inputting the multiple groups into a trained optical flow module respectively;

an establishment unit configured to establish a video action classification optimization model based on a trained three-dimensional convolution neural network module, a preset optical flow substitution module and the first classifier module;

a second training unit configured to determine the trained video action classification optimization model, by training the video action classification optimization model based on the multiple groups of video frames, the standard classification category information corresponding to respective one of groups and the reference optical flow information.

In some embodiments, the second training unit is configured to:

determine the optical flow prediction information corresponding to respective one of multiple groups of video frames, by inputting the groups to the optical flow substitution module respectively;

determine the optical flow loss information corresponding to respective one of groups of video frames based on the reference optical flow information and the predicted optical flow information corresponding to respective one of groups;

determine the reference spatial feature information corresponding to respective one of groups of video frames by inputting the multiple groups to the trained three-dimensional convolution neural network module respectively;

determine the classification category prediction information corresponding to respective one of groups of video frames 1w inputting the optical flow prediction information and the reference spatial feature information corresponding to respective one of groups to a classifier module;

determine the classification loss information corresponding to respective one of groups based on the standard classification category information and the classification category prediction information corresponding to respective one of groups;

adjust weight parameters in the optical flow substitution module based on the optical flow loss information and the classification loss information corresponding to respective one of groups of video frames, and adjust weight parameters in the classifier module based on the classification loss information corresponding to respective one of groups of video frames.

In some embodiments, the second training unit is configured to:

adjust weight parameters in the optical flow substitution module based on the optical flow loss information, the classification loss information and a preset adjustment proportional coefficient corresponding to respective one of groups of video frames, where the adjustment proportional coefficient represents an adjustment range for adjusting weight parameters.

In some embodiments, the second training unit is configured to:

determine the Euclidean distance between the reference optical flow information and the optical flow prediction information corresponding to each group of video frames as the optical flow loss information corresponding to each group of video frames.

With the apparatus provided by the embodiments of the disclosure, a plurality of video frames of the video to be classified can be directly input into the trained video action classification optimization model, the trained video action classification optimization model can automatically classify the video to be classified, and finally, the classification category information corresponding to the video to be classified is obtained, improving the efficiency of classification processing. In the process of classifying the video to be classified by the trained video action classification optimization model, it is no longer necessary to determine the optical flow diagrams corresponding to a plurality of video frames in advance based on a plurality of video frames of the video to be classified. The plurality of video frames of the video to be classified may be directly taken as the inputs of the optical flow substitution module in the model, and the optical flow substitution module can directly extract the optical flow information corresponding to the plurality of video frames of the video to be classified and determine the classification category information corresponding to the video to be classified based on the optical flow information, further improving the efficiency of classification processing.

Regarding the apparatus in the above embodiment, the specific manner in which each module performs the operations has been described in detail in the embodiments related to the method, and will not be illustrated in detail here.

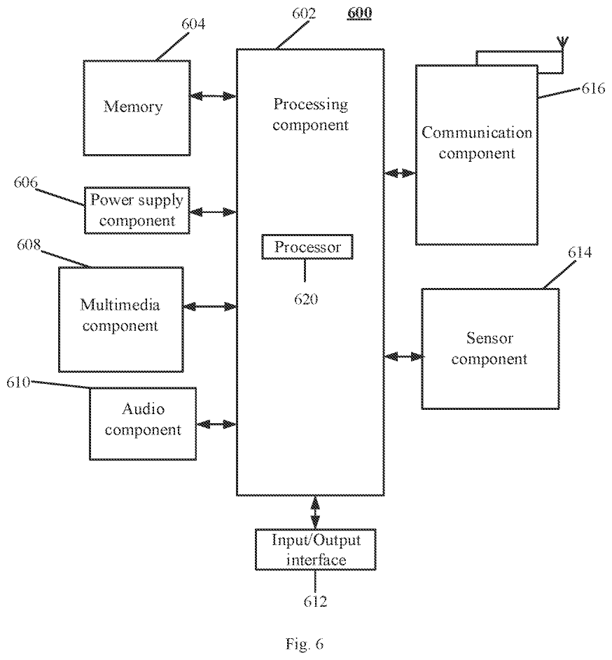

FIG. 6 is a block diagram of an apparatus for video action classification 600 according to an exemplary embodiment. For example, the apparatus 600 may be a computer device provided by some embodiments of the disclosure.

Referring to FIG. 6, the apparatus 600 may include one or more of a processing component 602, a memory 604, a power supply component 606, a multimedia component 608, an audio component 610, an input/output (I/O) interface 612, a sensor component 614, and a communication component 616.

The processing component 602 generally controls the overall operations of the device 600, such as operations associated with display, data communication and recording operation. The processing component 602 may include one or more processors 620 to execute instructions to complete all or a part of the steps of the above method. In addition, the processing component 602 may include one or more modules to facilitate the interactions between the processing component 602 and other components. For example, the processing component 602 may include a multimedia module to facilitate the interactions between the multimedia component 608 and the processing component 602.

The memory 604 is configured to store various types of data to support the operations of the apparatus 600. Examples of the data include instructions, messages, pictures, videos and the like of any application program or method operated on the apparatus 600. The memory 604 may be implemented by any type of volatile or nonvolatile storage device or a combination thereof, such as Static Random Access Memory (SRAM), Electrically Erasable Programmable Read Only Memory (EEPROM), Erasable Programmable Read Only Memory (EPROM), Programmable Read Only Memory (PROM), Read Only Memory (ROM), magnetic memory, flash memory, magnetic disk or optical disk.

The power supply component 606 provides power for various components of the apparatus 600. The power supply component 606 may include a power management system, one or more power supplies, and other components associated with generating, managing and distributing the power for the apparatus 600.

The multimedia component 608 includes a screen of an output interface provided between the apparatus 600 and the user. In some embodiments, the screen may include a Liquid Crystal Display (LCD) and a Touch Panel (TP). If the screen includes a touch panel, the screen may be implemented as a touch screen to receive input signals from the user.

The audio component 610 is configured to output and/or input audio signals. For example, the audio component 610 includes a microphone (MIC). When the apparatus 600 is in the operation mode such as recording mode and voice recognition mode, the microphone is configured to receive the external audio signals. The received audio signals may be further stored in the memory 604 or transmitted via the communication component 616. In some embodiments, the audio component 610 further includes a speaker for outputting the audio signals.

The I/O interface 612 provides an interface between the processing component 602 and a peripheral interface module, where the above peripheral interface module may be a keyboard, a click wheel, buttons or the like. These buttons may include but not limited to: home button, volume button, start button, and lock button.

The sensor component 614 includes one or more sensors for providing the apparatus 600 with the state assessments in various aspects. For example, the sensor component 614 may detect the opening/closing state of the apparatus 600, the relative positioning of components (for example, the display and keypad of the apparatus 600). and the temperature change of the apparatus 600.

The communication component 616 is configured to facilitate the wired or wireless communications between the apparatus 600 and other devices. The apparatus 600 may access a wireless network based on a communication standard, such as WiFi, operator network (e.g., 2G, 3G, 4G or 5G), or a combination thereof. In an exemplary embodiment, the communication component 616 receives the broadcast signal or broadcast related information from an external broadcast management system via a broadcast channel.

In some embodiments, the apparatus 600 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors or other electronic elements to perform the above method.

In some embodiments, a non-transitory computer readable storage medium including instructions, for example, the memory 604 including instructions, is further provided, where the above instructions can be executed by the processor 620 of the apparatus 600 to complete the above method. For example, the non-transitory computer readable storage medium may be ROM, Random Access Memory (RAM), CD-ROM, magnetic tape, floppy disk, optical data. storage device, or the like.

In some embodiments, a. computer program product is further provided. The computer program product, when executed by the processor 620 of the apparatus 600, enables the apparatus 600 to complete the above method.

After considering the specification and practicing the invention disclosed here, those skilled in the art will readily come up with other embodiments of the disclosure. The disclosure is intended to encompass any variations, usages or applicability changes of the disclosure, and these variations, usages or applicability changes follow the general principle of the disclosure and include the common knowledge or customary technological means in the technical field which is not disclosed in the disclosure. The specification and embodiments are illustrative only, and the true scope and spirit of the disclosure is pointed out by the following claims.

It should be understood that the disclosure is not limited to the precise structures which have been described above and shown in the figures, and can be modified and changed without departing from the scope of the disclosure. The scope of the disclosure is only limited by the attached claims.

What is claimed is:

1. A method for video action classification, comprising:
acquiring a video to be classified and determining a plurality of video frames in the video to be classified;
determining optical flow information corresponding to the plurality of video frames based on the plurality of video frames and an optical flow substitution module in a trained video action classification optimization model:
determining spatial feature information corresponding to the plurality of video frames based on the plurality of video frames and a three-dimensional convolution neural network module in the trained video action classification optimization model;
determining classification category information corresponding, to the video to be classified based on the optical flow information and the spatial feature information.

2. The method according to claim 1, further comprising:
training a video action classification model based on training samples, wherein the training samples comprise multiple groups of video frames and standard classification category information corresponding to each group of video frames, wherein the video action classification model comprises a three-dimensional convolution neural network module and an optical flow module;
determining reference optical flow information corresponding to each group of video frames based on each group of video frames and a trained optical flow module;
establishing a video action classification optimization model based on a trained three-dimensional convolution neural network module, a preset optical flow substitution module and a preset first classifier module;
determining the trained video action classification optimization model by training the video action classification optimization model based on the multiple groups of video frames, standard classification category information and the reference optical flow information corresponding to each group of video frames.

3. The method according to claim 2, wherein said that training the video action classification optimization model, comprises:
determining optical flow prediction information corresponding to each group of video frames, based on each group of video frames and the optical flow substitution module;
determining optical flow loss information corresponding to each group of video frames based on the reference optical flow information and the optical flow prediction information corresponding to each group of video frames;
determining reference spatial feature information corresponding to each group of video frames, based on each group of video frames and the trained three-dimensional convolution neural network module;
determining classification category prediction information corresponding to each group of video frames, based on the optical flow prediction information and the reference spatial feature information corresponding to each group of video frames and a preset second classifier module;
determining classification loss information corresponding to each group of video frames based on the standard classification category information and the classification category prediction information corresponding to each group of video frames;
adjusting weight parameters in the optical flow substitution module based on the optical flow loss information and the classification loss information corresponding to each group of video frames, and adjusting weight parameters in the first classifier module based on the classification loss information corresponding to each group of video frames.

4. The method according to claim 3, wherein said that adjusting weight parameters in the optical flow substitution module, comprises:
adjusting weight parameters in the optical flow substitution module based on the optical flow loss information, the classification loss information and a preset adjustment proportional coefficient corresponding to each group of video frames, wherein the adjustment proportional coefficient represents an adjustment range for adjusting weight parameters in the optical flow substitution module based on the optical flow loss information.

5. The method according to claim 3, wherein said that determining optical flow loss information corresponding to each group of video frames, comprises:
determining an Euclidean distance between the reference optical flow information and the optical flow prediction information corresponding to each group of video frames as the optical flow loss information corresponding to each group of video frames.

6. A computer device, comprising:
a processor;
a memory for storing instructions executable by the processor;
wherein the processor is configured to perform:
acquiring a video to be classified and determining a plurality of video frames in the video to be classified;
determining optical flow information corresponding to the plurality of video frames based on the plurality of video frames and an optical flow substitution module in a trained video action classification optimization model;
determining spatial feature information corresponding to the plurality of video frames based on the plurality of video frames and a three-dimensional convolution neural network module in the trained video action classification optimization model;
determining classification category information corresponding to the video to he classified based on the optical flow information and the spatial feature information

7. The computer device according to claim 6, comprising:
training a video action classification model based on training samples, wherein the training samples comprise multiple groups of video frames and standard classification category information corresponding to each group of video frames, wherein the video action classification model comprises a three-dimensional convolution neural network module and an optical flow module;
determining reference optical flow information corresponding to each group of video frames based on each group of video frames and a trained optical flow module;
establishing a video action classification optimization model based on a trained three-dimensional convolution neural network module, a preset optical flow substitution module and a preset first classifier module;
determining the trained video action classification optimization model by training the video action classification optimization model based on the multiple groups of video frames, standard classification category information and the reference optical flow information corresponding to each group of video frames.

8. The computer device according to claim 7, wherein said that training the video action classification optimization model, comprises:
determining optical flow prediction information corresponding to each group of video frames, based on each group of video frames and the optical flow substitution module;
determining optical flow loss information corresponding to each group of video frames based on the reference optical flow information and the optical flow prediction information corresponding to each group of video frames;
determining reference spatial feature information corresponding to each group of video frames, based on each group of video frames and the trained three-dimensional convolution neural network module;
determining classification category prediction information corresponding to each group of video frames, based on the optical flow prediction information and the reference spatial feature information corresponding to each group of video frames and a preset second classifier module;
determining classification loss information corresponding to each group of video frames based on the standard classification category information and the classification category prediction information corresponding to each group of video frames;
adjusting weight parameters in the optical flow substitution module based on the optical flow loss information and the classification loss information corresponding to each group of video frames, and adjusting weight parameters in the first classifier module based on the classification loss information corresponding to each group of video frames.

9. The computer device according to claim 8, wherein said that adjusting weight parameters in the optical flow substitution module, comprises:
adjusting weight parameters in the optical flow substitution module based on the optical flow loss information, the classification loss information and a preset adjustment proportional coefficient corresponding to each group of video frames, wherein the adjustment proportional coefficient represents an adjustment range for adjusting weight parameters in the optical flow substitution module based on the optical flow loss information.

10. The computer device according to claim 8, wherein said that determining optical flow loss information corresponding to each group of video frames, comprises:
determining an Euclidean distance between the reference optical flow information and the optical flow prediction information corresponding to each group of video frames as the optical flow loss information corresponding to each group of video frames.

11. A non-transitory computer-readable storage medium, wherein instructions in the storage medium, when executed by a processor of a computer device, enable the computer device to perform:
acquiring a video to be classified and determining a plurality of video frames in the video to be classified;
determining optical flow information corresponding to the plurality of video frames based on the plurality of video frames and an optical flow substitution module in a trained video action classification optimization model:
determining spatial feature information corresponding to the plurality of video frames based on the plurality of video frames and a three-dimensional convolution neural network module in the trained video action classification optimization model;
determining classification category information corresponding to the video to be classified based on the optical flow information and the spatial feature information.

12. The non-transitory computer-readable storage medium according to claim 11, further comprising:
training a video action classification model based on training samples, wherein the training samples comprise multiple groups of video frames and standard classification category information corresponding to each group of video frames, wherein the video action classification model comprises a three-dimensional convolution neural network module and an optical flow module;
determining reference optical flow information corresponding to each group of video frames based on each group of video frames and a trained optical flow module;
establishing a video action classification optimization model based on a trained three-dimensional convolution neural network module, a preset optical flow substitution module and a preset first classifier module;
determining the trained video action classification optimization model by training the video action classification optimization model based on the multiple groups of video frames, standard classification category information and the reference optical flow information corresponding to each group of video frames.

13. The non-transitory computer-readable storage medium according to claim 12, wherein said that training the video action classification optimization model, comprises:
determining optical flow prediction information corresponding to each group of video frames, based on each group of video frames and the optical flow substitution module;
determining optical flow loss information corresponding to each group of video frames based on the reference optical flow information and the optical flow prediction information corresponding to each group of video frames;
determining reference spatial feature information corresponding to each group of video frames, based on each group of video frames and the trained three-dimensional convolution neural network module;
determining classification category prediction information corresponding to each group of video frames, based on the optical flow prediction information and the reference spatial feature information corresponding to each group of video frames and a preset second classifier module;
determining classification loss information corresponding to each group of video frames based on the standard classification category information and the classification category prediction information corresponding to each group of video frames;
adjusting weight parameters in the optical flow substitution module based on the optical flow loss information and the classification loss information corresponding to each group of video frames, and adjusting weight parameters in the first classifier module based on the classification loss information corresponding to each group of video frames.

14. The non-transitory computer-readable storage medium according to claim 13, wherein said that adjusting weight parameters in the optical flow substitution module, comprises:
adjusting weight parameters in the optical flow substitution module based on the optical flow loss information, the classification loss information and a preset adjustment proportional coefficient corresponding to each group of video frames, wherein the adjustment proportional coefficient represents an adjustment range for adjusting weight parameters in the optical flow substitution module based on the optical flow loss information.

15. The non-transitory computer-readable storage medium according to claim 13, wherein said that determining optical flow loss information corresponding to each group of video frames, comprises:
determining an Euclidean distance between the reference optical flow information and the optical flow prediction information corresponding to each group of video frames as the optical flow loss information corresponding to each group of video frames.
